(19) United States
(12) Patent Application Publication
(10) Pub. No.: US 2009/0096630 A1
(43) Pub. Date: Apr. 16, 2009

(54) LASER LIGHTED GUIDANCE EXIT INDICATOR

(76) Inventor: David Belanger, Raynham, MA (US)

Correspondence Address: K.P. CORRELL AND ASSOCIATES, L.L.P., 270 BELLEVUE AVE., #326, NEWPORT, RI, 02840, US

(21) Appl. No.: 12/250,441

(22) Filed: Oct. 13, 2008

Related U.S. Application Data
(60) Provisional application No. 60/979,816, filed on Oct. 13, 2007.

(51) Int. Cl. G09F 9/33

(52) U.S. Cl. 340/815.45

(57) ABSTRACT

A lighted exit sign equipped with laser guidance capability is provided. The laser lighted guidance indicator includes at least one printed circuit (PC) board and associated circuitry for controlling the beam pattern of at least one Light Emitting Diode (LED) laser via at least one reflection device associated with the at least one LED laser. The evacuee is directed towards the exit by following the converging LED laser lights. The lighted exit sign may also include includes a display area and display microprocessor for controlling the display area. The display area may display alternate emergency messages such as “EXIT” and “SALIDA” or other language equivalents. The PC board, laser LEDs and reflectors are enclosed within a waterproof, shockproof, vibration tolerant, and theft deterrent enclosure.

### CROSS-REFERENCE TO RELATED APPLICATIONS

This application claims the benefit of U.S. Provisional Application No. 60/979,816 filed Oct. 13, 2007. The disclosure of this Provisional Patent Application is incorporated by reference herein in its entirety.

### BACKGROUND

1. Field of Use

The present invention relates generally to the field of lighted exit signs and more specifically to lighted exit signs equipped with laser guidance capability.

2. Description of Prior Art

The most common exit-finding aids are the ubiquitous illuminated overhead EXIT signs that satisfy .sctn.1023.0 of The Building Officials and Code Administrators International, Inc. National Building Code (BOCA), .sctn.4-7 of the National Fire Protection Association, Inc. Fire Prevention Code (NFPA 1), 14 CFR 25.812(b), 46 CFR 112.15-1(d), etc., and the simplified vision-dependent floor plans posted on or near the doors of hotel, motel and dormitory rooms, passenger ship cabins, etc. to satisfy NFPA 1 .sctn.16-2.4.1 and SOLAS II-2/28-1/1.7. While overhead EXIT signs are effective in clear air, they are hardly so when vision is compromised or when they are obscured by smoke, and the simplified floor plans are of doubtful effectiveness not only because they are vision-dependent aids that can also be obscured by smoke, but also because they are not readily interpreted by people unfamiliar with them.

Birch, U.K. Patent Application GB 2 214 681 A; Burkman et al, U.S. Pat. No. 4,347,499; Harrison, U.S. Pat. Nos. 4,737,764 & 4,794,373; Iwans, U.S. Pat. No. 4,029,994; and Shand, U.S. Pat. No. 4,754,266 attempt to address smoke obscuration of overhead signs with fixed or sequentially illuminated exit-finding aids at eye, hand or floor level, where they are less likely to be obscured by smoke, but are, unfortunately, more likely to suffer accidental or intentional damage. Further, these lower level aids are also both electrically powered and vision-dependent, and like the overhead signs, are ineffective when power supplies fail or vision is compromised. So too is the low-location lighting mandated by 14 CFR 25.812(e) and by II-2, Regulation 28/1.10 of the International Maritime Organization publication SOLAS.

Britt et al, U.S. Pat. No. 4,401,050; Davis, Canadian Patent 874554; Honigsbaum, U.S. Pat. No. 5,331,918; Keen et al, U.K. Patent Application GB 2 224154 A; Shriever, U.S. Pat. No. 4,385,586; and Smith et al, U.S. Pat. No. 5,027,741 teach exit-finding aids having tactile features that make them effective under all conditions of vision and visibility.

Britt, Davis, and Keen teach guide strips that tactilely indicate direction to an exit, and Keen's strips have overprinted arrows that serve visually, while Britt's strips also include a phosphorescent material intended to make them visually effective when lights fail. Davis' strips, however, have no visual features other than those inherent in their tactile arrangement because they are intended to serve when vision does not.

Honigsbaum teaches a system comprising a repetitive array of touch-and-sight-recognizable directional elements on the seats, tray tables and floors of aircraft passenger cabins to indicate direction to the nearest exit both tactilely and visually, and is the only one of the tactile arrangements mentioned that has alternative touch-and-sight-recognizable marking on main aisle floors that can satisfy 14 CFR 25.812(e)(1), i.e., to “—visually identify the emergency escape path along the cabin aisle floor to the first exits or pair of exits forward and aft—.” While both the alternative Honigsbaum arrangement and 14 CFR 25.812(e)(1) address the matter of direction to usable alternatives to unusable exits, neither addresses the plight of a passenger who leaves seat 41D in a Boeing 767-300 and struggles to reach an exit twenty seat rows forward because the aids of 14 CFR 25.812(e)(1) do not tell him the location of the nearest exit, i.e., the exit one seat-row aft.

Smith teaches a directional carpeting having fibers inclined to tactilely indicate direction to an exit and luminous arrow overlays to do so visually.

Shriever teaches arrowhead-shaped wall attachments that not only indicate direction to the nearest exit by touch as well as by sight, but also so indicate the number of doors to that exit by the number of such attachments arranged vertically on the “toward exit” side of a door, and by the number of bumps or dimples on each attachment. While Shriever's “number of doors” feature can be effective where only a few doors are involved, it merely adds to the confusion it is intended to eliminate when that number is large. Worse, Schriever's teachings not only ignore the possibility that an exit may be unusable by failing to indicate distance and direction to alternative ones; they redirect persons searching for usable alternatives right back to the unusable one!

Kennedy in publication WO/2006/077475A1 discloses multiple lasers and reflecting mirrors arranged along side hallway walls such that the laser discharge points to an exit. Yet, nowhere does Kennedy teach or suggest a single laser arrangement pointing from the exit into a room. Moreover, Kennedy's red/green hallway arrangement could be potentially dangerous, particularly where mariners are concerned. Mariners are taught the navigation rule of “red right returning”. In Kennedy, particularly in an emergency situation, mariners would likely be confused as to what direction they should be heading to find the exit since Kennedy teaches the red LEDs are on the left.

The exit-finding system of the present invention addresses the aforementioned shortcomings of the prior art discussed above.

### BRIEF SUMMARY

In accordance with one embodiment of the invention, a lighted exit sign equipped with laser guidance capability is provided. The laser lighted guidance indicator includes at least one printed circuit (PC) board and associated circuitry for controlling the beam pattern of at least one Light Emitting Diode (LED) laser via at least one reflection device associated with the at least one LED laser. The laser lighted guidance indicator also includes a waterproof enclosure for housing the PC board, the LED lasers, and the reflection devices.

The invention is also directed towards an emergency exit indicator system. The emergency exit indicator system includes a lit exit sign having a display area and display microprocessor for controlling the display area. The emergency exit indicator system also includes a Light Emitting Diode (LED) assembly having a printed circuit (PC) board and a plurality of LED lasers controllable by the PC board. A plurality of LED reflectors for reflecting laser light emitted by the plurality of LED lasers are also included with the emergency exit indicator system. The PC board, laser LEDs and reflectors are enclosed within a waterproof, shockproof, vibration tolerant, and theft deterrent enclosure.

### BRIEF DESCRIPTION OF THE DRAWINGS

FIG. 1 is a pictorial view of a lighted exit sign in accordance with the invention;

FIG. 2 is a pictorial view of a LED pattern diffuser in accordance with the invention shown in FIG. 1;

FIG. 3 is a pictorial view of a LED emission pattern in accordance with the invention shown in FIG. 1;

FIG. 4 is a pictorial view of an alternate embodiment of the present invention shown in FIG. 1;

FIG. 5 is schematic diagram of the LED assembly shown in FIG. 4;

FIG. 6 is a block diagram of a LED laser light diffuser in accordance with the invention shown in FIG. 4; and

FIGS. 6A and 6B are horizontal and vertical, respectively, pictorial views of LED laser light patterns in accordance with the laser light diffuser shown in FIG. 5 and FIG. 6.

### DETAILED DESCRIPTION

It will be appreciated that particles in the air make the laser beams visible. For example, a large-scale indoor laser light shows using relatively powerful, 5 watt (5000 mW) lasers, fog and smoke machines are typically used. Even when using lasers less than ½ watt (500 mW), fog and smoke are often a necessity to be able to view the laser light.

The present invention describes a fire exit sign having a laser light source, or sources, originating from a single point above an exit and fanning out over a room. Someone trying to find an exit during a fire where smoke has obscured the normal incandescent EXIT signs could follow the converging spokes of the laser light to find the exit. The laser light would be visible through smoke much more effectively than the small wattage incandescent lighting that illuminates more conventional exit signs. Indeed, it will be appreciated that the smoke would facilitate the visibility of the laser light. It will also be appreciated that the present invention may be used in diverse applications such as buildings, military battle fields, mining tunnels, caves, and under water locations. It will also be appreciated that the invention described herein may be used to signal search and rescue personnel anywhere air born particulates would inhibitor prevent more conventional signaling methods, used in a “Light House” to assist boat navigation or light house to point the device in a specific direction if the location of a vessel in distress is known “pointing” the way to safety. Other advantages of the invention described herein include intuitive directional light paths.

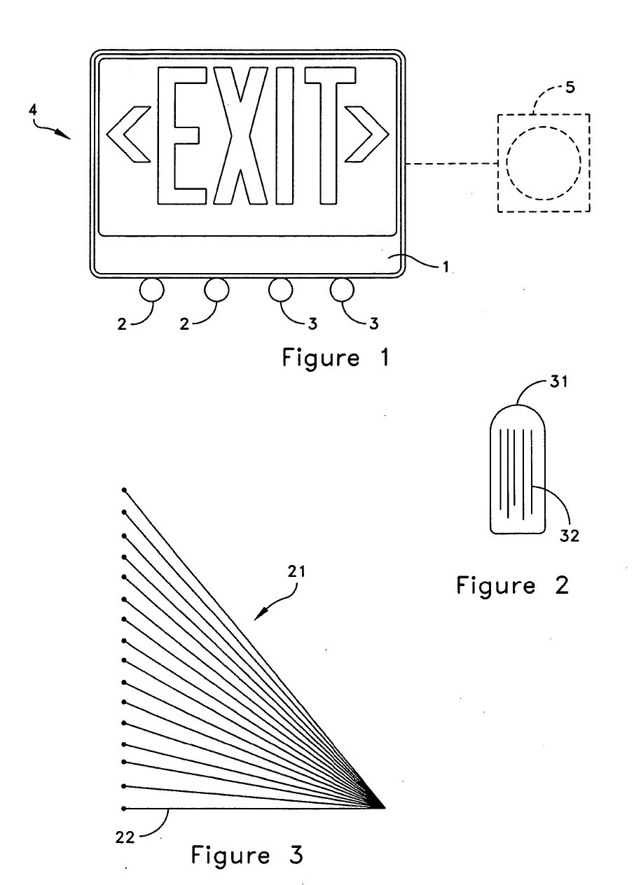

Referring to FIG. 1 there is shown a pictorial view of a lighted EXIT sign 4 in accordance with the invention. The EXIT portion of the sign 1 may be any suitable exit sign commonly available. Light emitting diodes (LED) 2 may be any suitable LASER LED of sufficient strength and color. Likewise, LEDs 3 may also be any suitable LASER LED of sufficient strength and color, where the LED 3 color may be similar to, or different from LED 2 color. It will also be appreciated that any number of LASER LEDs may be used to create patterns such as the fan-pattern 21 shown in FIG. 3, where each LASER LED produces a LASER LED beam 22 oriented in a particular direction. Also shown in FIG. 1, is optional speaker 5. It will be appreciated that optional speaker 5 may be include pre-recorded messages to correspond with the emergency. For example, in the case of a fire the pre-recorded message may be “Follow the Red LASER LED lighting to the nearest exit”. As described herein it will be understood that LED and LASER lighting may be used interchangeably.

Referring also to FIG. 2, there is shown a pictorial view of a LED diffuser 31 in accordance with the present invention shown in FIG. 1. The diffuser 31 includes slits 32, with sufficient reflectivity angles to deflect LED light in a desired pattern, e.g., the pattern shown in FIG. 3. It will be appreciated that multiple laser light beams, as described herein according to the present invention, fanning from a source are visible through out a smoke filled room, as opposed to a typical incandescent light source having a single sight line which may be blocked by obstacles such as tables or chairs, particularly if someone is lying on the floor to escape the smoke.

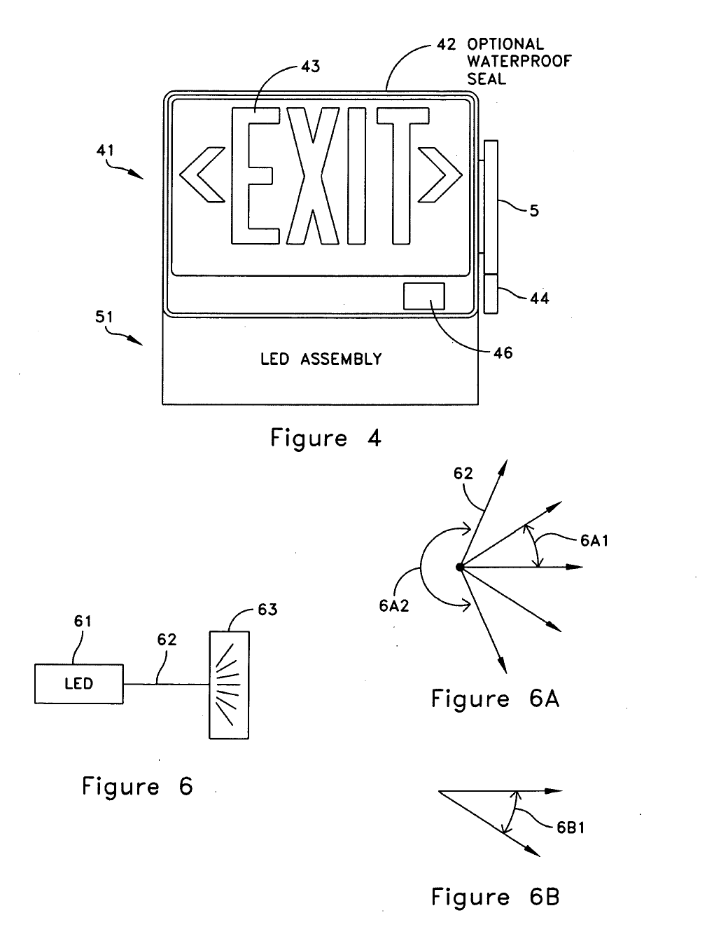

Referring to FIG. 4, there is shown a pictorial view of an embodiment of the present invention. EXIT sign 41 assembly includes display portion 43, an optional waterproof seal 42, optional speaker assembly 5 and associated voice generation system 44. Display portion 43 may be any suitable cutout display such as “EXIT” and may be backlit or otherwise illuminated as indicated in FIG. 4. In alternate embodiments the “EXIT” message may be generated on Display portion 43 using conventional means, e.g., light arrays. In these embodiments the Display portion 43 may also include display microprocessor 46 having logic and resources for displaying alternate messages. For example, Display portion 43 could alternate displaying “EXIT” and the Spanish equivalent “SALIDA”,

Still referring to FIG. 4 there is shown the optional waterproof seal 42 surrounding EXIT sign 41. The seal 42 may be any suitable waterproof seal such as a heat resistant or fire retardant gasket material. It will be appreciated that assembled EXIT sign 41 may be any suitable heat resistant, fire retardant, shock resistant, and water proof material preventing internal damage to EXIT sign 41.

Still referring to FIG. 4 there is shown optional speaker assembly 5 and associated voice generation system 44. Optional speaker assembly 5 may be any suitable heat resistant, fire retardant, shock resistant, and water proof speaker assembly. Also shown in FIG. 4 is the associated voice generation system 44 having logic and resources for generating pre-recorded alert messages or synthesizing alert messages. For example, voice generation system 44 may generate the word “EXIT” and/or its equivalent to be sounded on speaker assembly 5. For example the voice generation system 44 could generate the Spanish word for “exit”, i.e., “SALIDA”.

Also shown in FIG. 4 is LED assembly 51 discussed in more detail in FIG. 5. Referring also to FIG. 5 there is shown LED assembly 51. LED assembly 51 includes printed circuit (PC) board 54 having circuit and logic and resources for controlling LED lasers 55A-55G for maximizing visual detection of emanated laser light or reducing energy requirements.

It will be understood that while seven LED lasers are shown in FIG. 5, any suitable number of LED lasers may be used. For example, in an alternate embodiment, described herein, one LED Laser may be used. LED assembly 51 also includes enclosure 53, physical interface 57, and wireless interface 52. Physical interface may be any suitable physical interface, such as, for example, a universal serial bus (USB) interface. Likewise, wireless interface 52 may be any suitable interface such as, for example, a cellular phone interface. It will also be understood that any suitable LED laser may be used. For example, an LED laser with 532 nm Wave Length (green) Light Emissions may be used; where an advantage of green light is increased visibility to the human eye than when compared to red light and lower power consumption to achieve a similar effect when using red LED lasers. Similarly blue or blue-green light lasers may be used in underwater environments. In addition, LED assembly 51 includes reflective mirrors 56A-56G, associated with each of the LED lasers 55A-55G.

PC board 54 also contains logic and resources for pulsed laser emissions for improving visual detection and reducing energy requirements. PC board 54 also includes separate diode drivers for protecting laser diode from heat and adding flexibility in positioning the laser module. Still referring to FIG. 5 and PC board 54, PC board 54 includes logic and resources for controlling output power for better illumination and deeper penetration of air born particulates. For example, PC board 54 may include local smoke sensor 54A for sensing smoke density and adjusting LED laser output wattage for maximum visibility in accordance with sensed smoke density and prolong battery life in low smoke density environments. It will be understood that PC board 54 may also receive smoke density data via remote sources via its wireless controller 52 or its physical interface 57.

Still referring to FIG. 5, PC board 54 may compatible with any suitable power source such as 24 VDC Compatible or other standard fire 24 VDC Fire Signal Appliance Circuits.

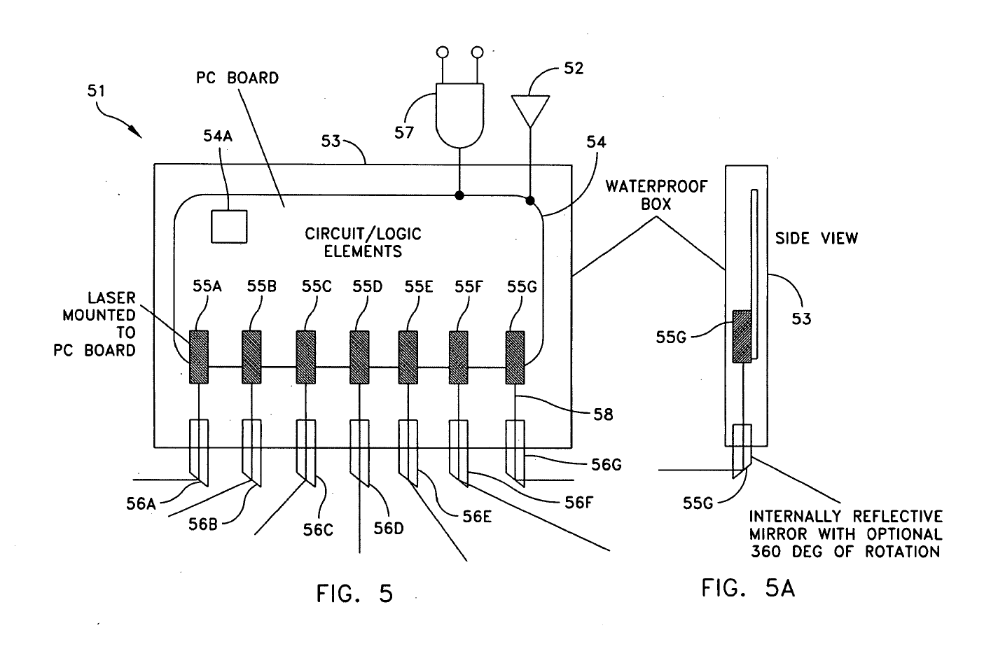

Still referring to FIG. 5, for applications where the unit may be exposed to rain, sprinklers, splashes, fire hose water, condensation, etc., enclosure 53 may be any suitable heat resistant, fire retardant, shock resistant, dust proof, and water proof enclosure preventing internal damage to LED assembly 51. Thus allowing operation under water and higher reliability in harsh or wet environments; e.g., underwater, earthquake events. Enclosure 53 may be suitable constructed and mounted to prevent, or reduce the risk of electrical shock; and impede access to LED lasers to prevent LED laser theft. Enclosure 53 may also be partially translucent to allow reflection devices 56 (or diffuser 63 shown in FIG. 6) to transmit LED laser light through enclosure 53.

Physical interface 57 shown in FIG. 5 provides logical access to PC board 54. This access may be connectable to one or more external fire alarm systems or sensors suitable for indicating an emergency situation. Likewise, wireless interface 52 may be connectable to one or more external fire alarm systems or sensors suitable for indicating an emergency situation. For example, wireless interface 52 may be accessible by emergency personnel, e.g., firemen, for controlling LED assembly 51 for assisting fireman in finding their way back out of a smoke filled building; or automobile signaling in fog, rain or snow to assist a person in locating a parked car in a crowded parking lot; or boat signaling for search and rescue; or person to person signaling for search and rescue. Via its wireless 52 or physical interface 57 the LED assembly 51 producing a laser fan (see FIG. 6A) or other indicating shape may also be in communication with other fire information sources; the light producing source could then change its shape (FIG. 6A, adjustable angles 6A1 and 6A2) to indicate that its respective exit is not available or safe to exit through.

Still referring to FIG. 5 LED assembly 51 includes reflective mirrors 56A-56G. Reflective mirrors 56A-56G may be any suitable mirror for reflecting LED laser generated light 58. The physical orientation of the reflective mirrors 56A-56G may be preset to achieve the desired reflection angle for the LED light 58 generated by the respective LED lasers 55A-55G. In an alternate embodiment the physical orientation of each of the reflective mirrors 56A-56G may be electronically controlled by PC board 54. It will also be appreciated that the orientation of reflective mirrors 56A-56G may be customizable for room size, odd shaped rooms, unwanted reflections, obstructions and to permit flexible horizontal and vertical placement of LED assembly 51.

Referring also to FIG. 5A there is shown a side profile view of the invention shown in FIG. 5. It will be appreciated that FIG. 5A illustrates the low profile footprint aspect of the invention.

Referring now to FIG. 6 there is shown a single LED laser option referenced earlier. In this option LED laser 61 emits laser light 62 which is diffused by diffuser 63. Diffuser 63 may be any suitable optical diffuser such as, for example, ground glass diffusers, Teflon diffusers, holographic diffusers, opal glass diffusers, or greyed glass diffusers. Any suitable diffuser 63 may be pre-configured or controllable by PC board 54 to provide controllable horizontal and vertical beam patterns as shown in FIG. 6A and FIG. 6B, respectively. It will also be appreciated that diffuser may be customizable for room size, odd shaped rooms, unwanted reflections, obstructions and to permit flexible horizontal and vertical placement of LED assembly 51. In addition, diffuser 63 may be adjustable for maximizing visual detection of emanated laser light or reducing energy requirements.

It is understood that the present invention may use any suitable laser wavelength and or laser light pattern. For example, as discussed above one suitable laser light shape is a fan shape indicating an exit area. Multiple fan-shapes emanating from different areas of a space, each having different laser wavelengths, i.e., color, may be used to indicate different exit areas.

Another embodiment of the invention is a system of laser light sources converging to produce shapes and or other information indicating an exit. For example converging laser light sources may be suitably arranged to converge so as to produce one or more arrow shapes indicating the direction of an exit as well as the distance to the exit.

The various features of novelty which characterize the invention are pointed out with particularity in the claims annexed to and forming a part of the disclosure. For a better understanding of the invention, its operating advantages, and specific objectives attained by its use, reference should be had to the drawings and descriptive matter in which there are illustrated and described embodiments of the invention.

What is claimed is:

1. A laser lighted guidance indicator, the laser lighted guidance indicator comprising:
at least one printed circuit (PC) board;
at least one Light Emitting Diode (LED) laser controllable by the at least one PC board;
at least one reflection device associated with the at least one LED laser; and
a waterproof enclosure for housing the at least one PC board, the at least one LED laser, and the at least one reflection device.

2. The laser lighted guidance indicator as in claim 1, wherein the at least one LED laser comprises a red light emission LED laser.

3. The laser lighted guidance indicator as in claim 1, wherein the at least one LED laser comprises a green light emission LED laser.

4. The laser lighted guidance indicator as in claim 1, wherein the at least one LED laser comprises a blue light emission blue laser.

5. The laser lighted guidance indicator as in claim 1 where in the at least one reflection device comprises at least one reflective mirror.

6. The laser lighted guidance indicator as in claim 1 where in the at least one reflection device comprises an optical diffuser.

7. The laser lighted guidance indicator as in claim 1 further comprising a wireless interface.

8. The laser lighted guidance indicator as in claim 1 further comprising a physical interface.

9. The laser lighted guidance indicator as in claim 1 further comprising at least one smoke density sensor.

10. The laser lighted guidance indicator as in claim 1 further comprising a voice generation system, wherein the voice generation system comprises:
at least one speaker; and
and at least one voice generator for generating audible messages to be broadcast on the at least one speaker.

11. The laser lighted guidance indicator as in claim 1 further comprising an exit sign, wherein the exit sign comprises:
a display area; and
a display microprocessor for controlling the display area.

12. An emergency exit indicator system, wherein the emergency exit indicator system comprises:
an exit sign, wherein the exit sign comprises:
a display area;
a display microprocessor for controlling the display area;
a Light Emitting Diode (LED) assembly, wherein the LED assembly comprises:
at least one printed circuit (PC) board;
a plurality of LED lasers controllable by the at least one PC board;
a plurality of LED reflectors for reflecting laser light emitted by the plurality of LED lasers, wherein each of the plurality of LED reflectors correspond with each of the plurality of LED reflectors; and
a waterproof enclosure for housing the at least one PC board, the plurality of LED lasers, and the plurality of LED reflectors.

13. The emergency exit indicator system as in claim 12 wherein one of the pluralities of LED lasers comprises one red LED laser.

14. The emergency exit indicator system as in claim 12 wherein one of the pluralities of LED lasers comprises one green LED laser.

15. The emergency exit indicator system as in claim 12 wherein one of the pluralities of LED lasers comprises one blue-green LED laser.

16. The emergency exit indicator system as in claim 12 wherein each of the plurality of LED reflectors comprises at least one reflective mirror.

17. The emergency exit indicator system as in claim 12 wherein each of the plurality of LED reflectors comprises at least one optical diffuser.

18. The emergency exit indicator system as in claim 12 further comprising a wireless interface.

19. The emergency exit indicator system as in claim 12 further comprising at least one smoke density sensor.
